(19) United States
(12) Patent Application Publication
(10) Pub. No.: US 2007/0095624 A1
(43) Pub. Date: May 3, 2007

(54) Saddle-type vehicle and steering damper for use in the same

(75) Inventor: Norimasa ITO, Shizuoka (JP)

Correspondence Address: HOGAN & HARTSON L.L.P., 1999 AVENUE OF THE STARS, SUITE 1400, LOS ANGELES, CA, 90067, US

(73) Assignees: YAMAHA HATSUDOKI KABUSHIKI KAISHA, Iwata-shi (JP); Yamaha Motor Co., Ltd.

(21) Appl. No.: 11/549,369

(22) Filed: Oct. 13, 2006

(30) Foreign Application Priority Data
Oct. 17, 2005 (JP) 2005-302288

(51) Int. Cl. F16F 9/00

(52) U.S. Cl. 188/314

(57) ABSTRACT

A steering damper with improved layout relative to nearby components includes a piston cylinder extending axially in a straight line, a piston slidably disposed in the piston cylinder, a first piston rod extending in a straight line from one end face of the piston, and a second piston rod extending in a straight line from the other end face of the piston. The leading ends of the first and second piston rods are mounted to first and second brackets of an under bracket. The piston cylinder and a damper mounting frame are joined together with a link.

### RELATED APPLICATIONS

This application claims the benefit of priority under 35 USC 119 of Japanese patent application no. 2005-302288, filed on Oct. 17, 2005, which application is hereby incorporated by reference in its entirety.

### BACKGROUND OF THE INVENTION

1. Field of the Invention

The present invention relates to a saddle-type vehicle such as a motorcycle and a steering damper for use in the same.

2. Description of Related Art

Riders of motorcycles sometimes feel uncomfortable or cannot steer smoothly during driving when vibrations from a road or the like are applied to the steering. Accordingly, to reduce vibrations, some motorcycles are equipped with a steering damper for improving steering operability, for example, between the body frame and the under bracket.

However, with this conventional technique, when the steering angle is large, an end of a piston rod projects greatly from a piston cylinder. To prevent interference between the great projection of the piston rod and components of the vehicle body, such as a cowling for covering the vehicle body, a large space is needed around the steering damper. This makes it difficult to design the layout of the vehicle components disposed around the steering damper.

To solve this problem, a motorcycle is proposed in which interference between the projection of the piston rod and the vehicle components is prevented by a curved structure of the steering damper (refer to JP-UM-A-1-175494).

However, since the motorcycle disclosed in JP-UM-A-1-175494 is constructed with a steering damper curved in an arc shape, the steering damper must be curved by pressing or the like at manufacture. This leads to the problems of increased man-hours and high manufacturing costs.

### SUMMARY OF THE INVENTION

The present invention is made in light of such circumstances and provides a saddle-type vehicle and steering damper in which the layout of the components of the vehicle around the steering damper are easily designed and the steering damper is manufactured at reduced man-hours and cost.

A saddle-type vehicle according to the invention includes a body frame, an under bracket mounted to a steering shaft supported by the body frame and a steering damper that causes attenuation during steering. The steering damper includes a piston cylinder mounted to the body frame, a piston slidably disposed in the piston cylinder and causing attenuation during sliding in the piston cylinder, a first piston rod projecting from one end face of the piston to the outside of the piston cylinder, the projecting end being fixed to an longitudinal end of the under bracket of the body, and a second piston rod projecting from the other end face of the piston to the outside of the piston cylinder, the projecting end being fixed to the other longitudinal end of the under bracket of the body. The projection of the first piston rod and the projection of the second piston rod are in a line.

This arrangement prevents change of the positional relationship between the steering damper and the under bracket even when the steering is turned, which enables the steering load to be directed on a tangential line of the steering circle when the steering is turned. Therefore, the steering load is not changed according to the steering angle, allowing stable steering operation.

When the steering is turned in one direction, the first piston rod extends from the piston cylinder, and the second piston rod contracts into the piston cylinder by the amount of the extension of the first piston rod. On the other hand, when the steering is turned in the other direction, the second piston rod extends from the piston cylinder, and the first piston rod contracts into the piston cylinder by the amount of the extension of the second piston rod.

Accordingly, the entire length of the steering damper including the piston cylinder and the first and second piston rods is held at a fixed length whichever direction the steering is turned, thus preventing the piston rod from projecting greatly from the under bracket, unlike the conventional art. Thus interference between the first and second piston rods and vehicle components around the steering damper is prevented.

The piston cylinder and the first and second piston rods of the steering damper extend in a straight line between the first and second brackets. This arrangement eliminates the need for pressing the steering damper as in the conventional art.

According to an embodiment of the invention, the steering shaft is mounted to substantially the center of the under bracket, a pair of front forks are mounted to both ends of the under bracket with the steering shaft therebetween and the first and second piston rods are mounted to the under bracket at the same vehicle width as the pair of front forks. With this arrangement, even if the steering angle is at the maximum, interference between the steering damper and vehicle components around the steering damper is prevented.

According to an embodiment of the invention, the steering damper is disposed on the back of the under bracket. With this arrangement, the steering damper is disposed in the space on the back of the under bracket and facilitates the layout design of the steering damper.

According to an embodiment of the invention, the steering damper is disposed in parallel with the length of the under bracket. With this arrangement, the steering damper is disposed compactly in the space around the under bracket, further facilitating the layout design of the steering damper. Moreover, the right and left steering loads are balanced when the steering is turned.

The arrangement of a saddle-type vehicle and steering damper according to the invention prevents ends of the piston rod from projecting greatly from the under bracket, in contrast to conventional steering dampers, and facilitates the layout design of various vehicle components around the steering damper. Moreover, the need for pressing the steering damper is eliminated and thereby reduces man-hours and manufacturing costs of the steering damper.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a side view of a motorcycle according to an embodiment of the invention.

FIG. 2 is an enlarged diagram of a front pipe, a head pipe and a steering damper of the motorcycle of FIG. 1.

FIG. 3 is a plan view of an under bracket and the steering damper, as viewed in the direction of arrow III-III in FIG. 2.

FIG. 4 is the plan view of FIG. 3, with the steering turned.

### DETAILED DESCRIPTION OF THE INVENTION

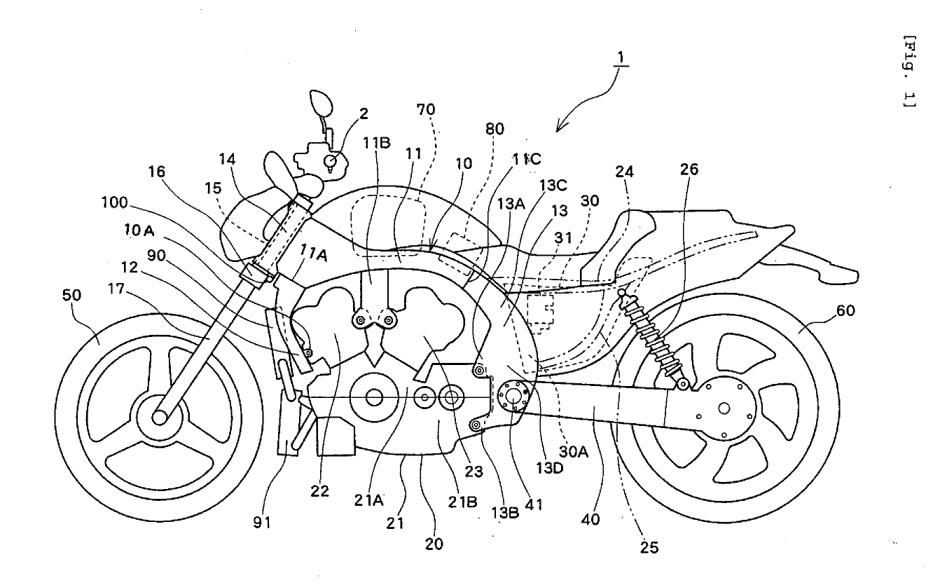

The present invention is described in detail below according to an embodiment applied to a motorcycle with reference to FIG. 1-4. A motorcycle 1 includes right and left main pipes 10 (only one is shown), an engine 20, and a steering damper 100.

Main pipes 10 serve as the frame of the vehicle. Main pipes 10 each include an intermediate pipe 11 extending substantially horizontally in a front-back direction above engine 20, a front pipe 12 welded at an upper end to a front end 11A of intermediate pipe 11 and extending from front end 11A downward in front of engine 20, and a rear pipe 13 welded at an upper end to a rear end 11C of intermediate pipe 11 and extending from the rear end downward on the back of engine 20. A damper mounting frame 12A projects from the front end lower part of front pipe 12, to which steering damper 100 is mounted through a link 105, to be described later. Front end 11A of intermediate pipe 11 is located toward the front of engine brackets 13A and 13B of rear pipe 13.

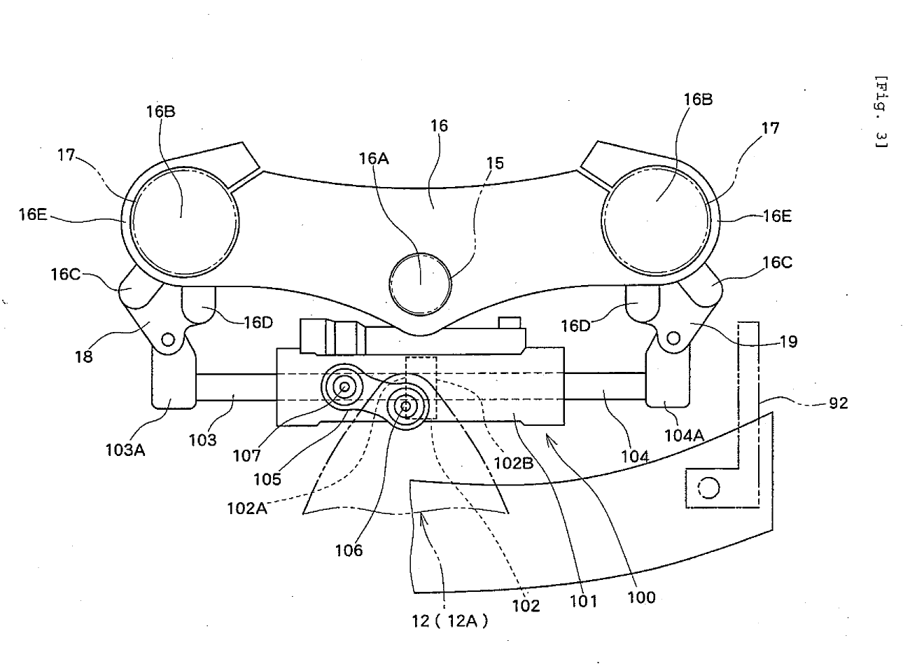

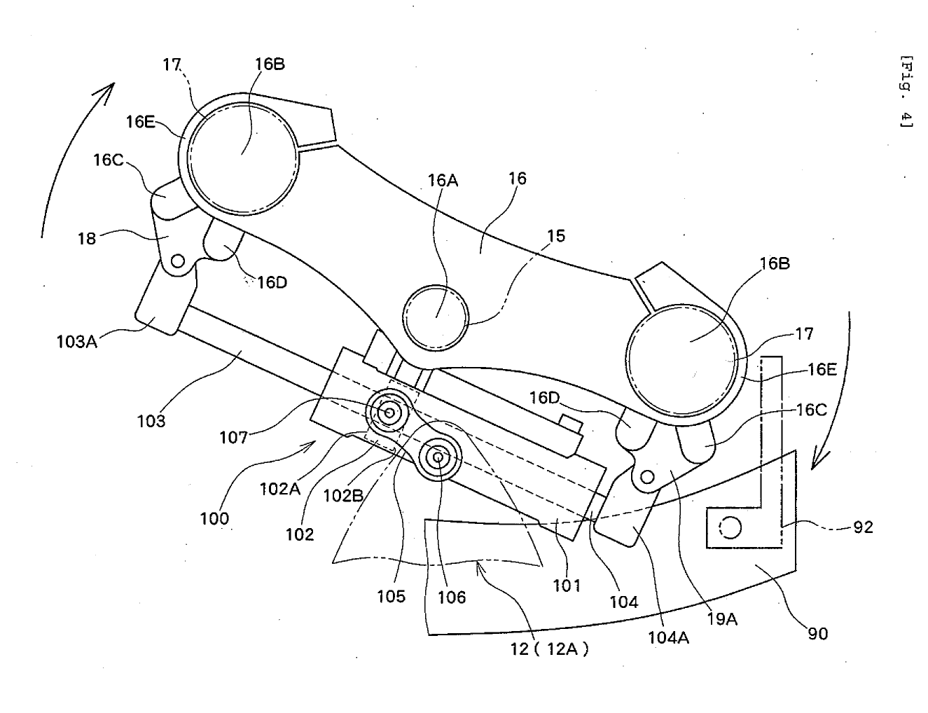

An engine bracket 10A projects from the lower end of front pipe 12. Engine bracket 10A fixes a front cylinder 22 of engine 20. Front pipe 12 is welded to right and left radiator brackets 92 (only one is shown), as indicated by the chain double-dashed lines of FIGS. 3 and 4, to which an upper radiator 90 is mounted. An engine bracket 11B is disposed in the middle of the length of intermediate pipe 11. Engine bracket 11B extends from intermediate pipe 11 downward and between front cylinder 22 and rear cylinder 23 of engine 20. The lower end of engine bracket 11B is forked. Front cylinder 22 and rear cylinder 23 are fixed to the lower end of engine bracket 11B.

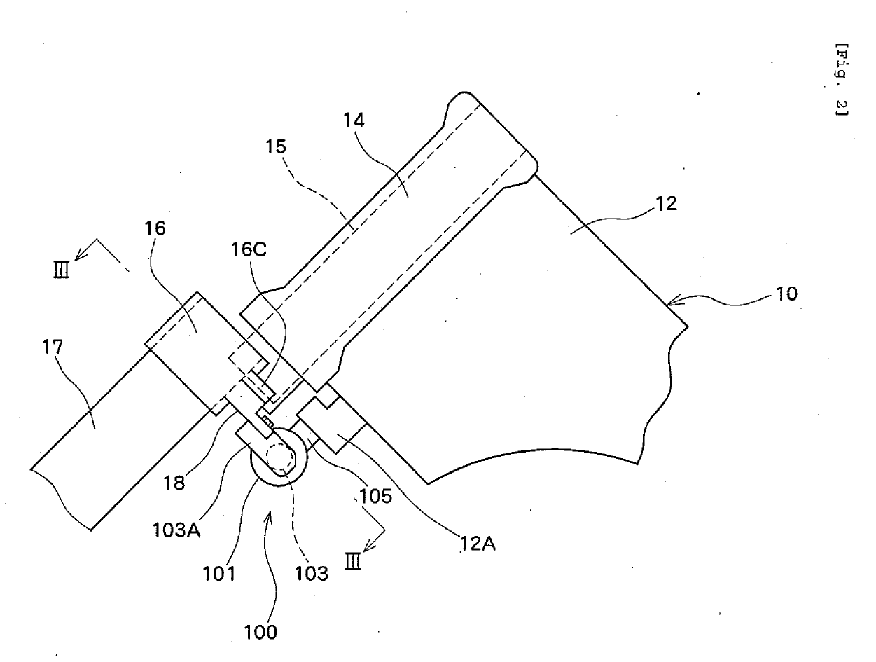

Rear pipe 13 at the rear of main pipe 10, as shown in FIGS. 1 and 2, extends downward from rear end 11C of intermediate pipe 11 toward the back of a pivot shaft 41, in the form of an arc. Rear pipe 13 includes upper engine bracket 13A and lower engine bracket 13B projecting from the lower end apart from each other. Upper engine bracket 13A and lower engine bracket 13B are fitted with an upper case 21A and a lower case 21B of engine 20, respectively. Rear pipe 13 overlaps with front part 30A of fuel tank 30 at the rear of engine 20 in side view. The upper part 13C of rear pipe 13 is narrow in side view, while the lower part is wide in side view.

The lower part 13D of rear pipe 13 is pivotally connected to the front end of a swing arm 40 with pivot shaft 41. The rear end of swing arm 40 is rotatably connected to the steering shaft of a rear wheel 60.

Main pipe 10 is bolted to a seat rail 24 extending rearward from upper part 13C of rear pipe 13. Lower part 13D of rear pipe 13 is bolted to a backstay 25 extending obliquely to the upper rear in a curve. The upper end of backstay 25 is bolted to the middle of seat rail 24. A shock absorber 26 is provided between the upper end of backstay 25 and the rear end of swing arm 40.

A head pipe 14 is welded to the front end of intermediate pipe 11 of main pipe 10. Head pipe 14 is rotatably fitted on a steering shaft 15 disposed to a handle 2. Steering shaft 15 is fitted at the lower end with an under bracket 16. Steering shaft 15 is supported in head pipe 14 constituting part of the frame. Head pipe 14 is fitted at the lower end with the under bracket 16.

Referring to FIG. 3, under bracket 16 comprises a substantially oblong plate extending in a lateral direction. Under bracket 16 has a steering-shaft insertion hole 16A in the middle in a longitudinal direction (substantially in the center). The lower end of steering shaft 15 is inserted and fixed in steering-shaft insertion hole 16A. Under bracket 16 has front-fork insertion holes 16B and 16B at opposite ends in the longitudinal direction. The upper ends of right and left front forks 17 are inserted and fixed in front-fork insertion holes 16B and 16B. In other words, front forks 17 are mounted to opposite ends of under bracket 16 with steering shaft 15 therebetween. The lower ends of front forks 17 are rotatably connected to a front wheel 50. Under bracket 16 has left support plates 16C and 16D and right support plates 16C and 16D projecting from both sides. Left support plates 16C and 16D hold a first bracket 18, and right support plates 16C and 16D hold a second bracket 19.

Steering damper 100 includes a piston cylinder 101, a piston 102, a first piston rod 103, a second piston rod 104, and a link 105. As shown in FIG. 3, steering damper 100 is located on the back of under bracket 16 and substantially in parallel with the length of under bracket 16.

Piston cylinder 101 extends axially in a straight line and is filled with liquid oil. Piston 102 is shaped like a disk and is slidably disposed in piston cylinder 101. Piston 102 has an orifice (not shown), through which liquid oil circulates when piston 102 slides axially in piston cylinder 101, thereby causing attenuation. Referring to FIG. 3, the left end face of piston 102 is indicated by numeral 102A, and the right end face is indicated by numeral 102B.

First piston rod 103 is in the form of a column extending axially in a straight line, whose trailing end is secured to end face 102A of piston 102. The leading end of first piston rod 103 extends axially in piston cylinder 101 to project to the outside of piston cylinder 101, to which a damper mounting portion 103A is fixed. Damper mounting portion 103A is bolted to first bracket 18.

Second piston rod 104 is also in the form of a column extending axially in a straight line, whose trailing end is secured to end face 102B of piston 102. The leading end of second piston rod 104 extends axially in piston cylinder 101 to project to the outside of piston cylinder 101, to which a damper mounting portion 104A is fixed. Damper mounting portion 104A is bolted to second bracket 19. The projections of first piston rod 103 and second piston rod 104 are in a line. As shown in FIG. 3, first piston rod 103 and second piston rod 104 are mounted to under bracket 16 with first and second brackets 18 and 19, respectively, at the same vehicle width as the pair of front forks 17.

As shown in FIG. 3, link 105 is a substantially oblong plate that is narrow in the middle of the length. A longitudinal end of link 105 is rotatably joined to damper mounting frame 12A projecting from front pipe 12 with a pin 106. The other longitudinal end of link 105 is rotatably joined to piston cylinder 101 with a pin 107.

Engine 20 is preferably a V-four-cylinder engine. Engine 20 includes a crankcase 21 divided into upper and lower sections: upper case 21A and lower case 21B. Right and left front cylinders 22 (only one is shown) extend obliquely from the upper front of upper case 21A to the upper front, and right and left rear cylinders 23 located on the back of front cylinder 22 extend obliquely from the top of upper case 21A to the upper rear. Engine 20 is suspended from main pipes 10 by engine brackets 10A, 11B, 13A, and 13B.

A pump 31 for supplying fuel to engine 20 is disposed at the front of fuel tank 30 and in the vicinity of rear pipe 13. An air cleaner 70 is disposed on intermediate pipe 11. A battery 80 is disposed on intermediate pipe 11 between air cleaner 70 and fuel tank 30. Upper radiator 90 and lower radiator 91 are disposed between engine 20 and front wheel 50. Upper radiator 90 is fixed to radiator bracket 92 and welded to front pipe 12, while lower radiator 91 is secured to crankcase 21.

When motorcycle 1 is steered clockwise, e.g., along the arrow in FIG. 4, around steering shaft 15, steering damper 100 is inclined in parallel with under bracket 16 through link 105, while first piston rod 103 extends from piston cylinder 101. Second piston rod 104 is contracted into piston cylinder 101 by an amount corresponding to the extension of first piston rod 103.

When motorcycle 1 is steered counterclockwise ((not shown) about steering shaft 15, steering damper 100 is inclined in parallel with under bracket 16 through link 105, while second piston rod 104 extends from piston cylinder 101. First piston rod 103 is contracted into piston cylinder 101 by an amount corresponding to the extension of second piston rod 104.

The embodiment is constructed such that the projection of first piston rod 103 and the projection of second piston rod 104 are in a line. Accordingly, the entire length of steering damper 100 including piston cylinder 101 and first and second piston rods 103 and 104 can be held at a fixed length whichever direction (clockwise and counterclockwise) the steering is turned. This prevents the piston rod from projecting greatly from the under bracket, unlike the conventional art, to thereby prevent interference between first and second piston rods 103 and 104 and the various vehicle components around steering damper 100, thus facilitating the layout design of the components.

The embodiment is constructed such that piston cylinder 101 of steering damper 100 and first and second piston rods 103 and 104 extend in a straight line between first and second brackets 18 and 19. This eliminates the need for pressing the steering damper 100, as in the conventional art, thereby reducing man-hours and manufacturing cost of steering damper 100.

Furthermore, first and second piston rods 103 and 104 are mounted to under bracket 16 at the same vehicle width as the pair of front forks 17. Accordingly, even if steering damper 100 is greatly turned as shown in FIG. 4, there is no interference between an end 16E of under bracket 16 and radiator bracket 92 in the vicinity thereof, thus preventing damage of under bracket 16.

The embodiment is constructed such that rear pipe 13 at the rear of main pipe 10 is curved into an arc shape. This prevents the load of engine 20 from being concentrated locally on the bent portion of the main pipe when rear pipe 13 is joined to crankcase 21, thus allowing the load to be evenly applied to the entire main pipe 10 to thereby increase the rigidity of the main pipe.

Rear pipe 13 is joined to crankcase 21 via the back of pivot shaft 41. Accordingly, the load of engine 20 transmitted to the rear of main pipe 10 is surely received by rear pipe 13, in contrast to the conventional art in which the rear pipe extends from the rear end of the front pipe substantially vertically downward in a straight line to be joined to the crankcase. This also increases the rigidity of main pipe 10, improving the performance and reliability of motorcycle 1.

The invention has been described using motorcycle 1 as an example of a saddle-type vehicle. However, the invention is not limited to that, and may be applied to other saddle-type vehicles such as motor three wheelers and buggies.

The particular embodiments of the invention described in this document should be considered illustrative, rather than restrictive. Modification to the described embodiments may be made without departing from the spirit of the invention as defined by the following claims.

1. A saddle-type vehicle comprising:
a body frame;
an under bracket mounted to a steering shaft supported by the body frame; and
a steering damper that causes attenuation during steering, wherein the steering damper comprises:
a piston cylinder mounted to the body frame;
a piston slidably disposed in the piston cylinder and causing attenuation during sliding in the piston cylinder;
a first piston rod projecting from one end face of the piston to an outside of the piston cylinder, the projecting end being fixed to a longitudinal end of the under bracket; and
a second piston rod projecting from an other end face of the piston to the outside of the piston cylinder, the projecting end being fixed to an other longitudinal end of the under bracket, wherein
the projection of the first piston rod and the projection of the second piston rod are in a line.

2. The saddle-type vehicle according to claim 1, wherein the steering shaft is mounted to substantially a center of the under bracket; a pair of front forks is mounted to both ends of the under bracket with the steering shaft therebetween; and the first piston rod and the second piston rod are mounted to the under bracket at a same vehicle width as the pair of front forks.

3. The saddle-type vehicle according to claim 1, wherein the steering damper is disposed on a back of the under bracket.

4. The saddle-type vehicle according to claim 1, wherein the steering damper is disposed in parallel with a length of the under bracket.

5. The saddle-type vehicle according to claim 2, wherein the steering damper is disposed on a back of the under bracket.

6. The saddle-type vehicle according to claim 2, wherein the steering damper is disposed in parallel with a length of the under bracket.

7. The saddle-type vehicle according to claim 1, and further comprising a link for mounting the piston cylinder to the body frame, wherein one longitudinal end of the link is rotatably joined to a damper mounting frame projecting from a front pipe of the frame, and another longitudinal end of the link is rotatably joined to the piston cylinder.

8. The saddle-type vehicle according to claim 7, wherein the link is a substantially oblong plate that is narrower in a middle portion.

9. The saddle-type vehicle according to claim 7, wherein in a state where the vehicle is steered clockwise:
the steering damper is inclined in parallel with the under bracket through the link;
the first piston rod extends from the piston cylinder; and
the second piston rod contracts into the cylinder by an amount corresponding to the extension of the first piston rod.

10. The saddle-type vehicle according to claim 7, wherein in a state where the vehicle is steered counterclockwise:
the steering damper is inclined in parallel with the under bracket through the link;
the second piston rod extends from the piston cylinder; and
the first piston rod contracts into the cylinder by an amount corresponding to the extension of the second piston rod.

11. The saddle-type vehicle according to claim 1, wherein an entire length of the steering damper, including the piston cylinder and the first and second piston rods, maintains a fixed length regardless of which direction the vehicle is steered, thereby preventing the piston rods from projecting greatly from the under bracket and preventing interference between the piston rods and adjacent components of the vehicle.

12. The saddle-type vehicle according to claim 1, wherein the vehicle is a motorcycle.

13. A steering damper for use in a saddle-type vehicle, the steering damper comprising:
a piston cylinder mountable to a body frame with a link;
a piston slidably disposed in the piston cylinder and causing attenuation during sliding in the piston cylinder;
a first piston rod projecting from one end face of the piston to an outside of the piston cylinder, the projecting end being fixed to a longitudinal end of an under bracket with a first bracket; and
a second piston rod projecting from an other end face of the piston to the outside of the piston cylinder, the projecting end being fixed to an other longitudinal end of the under bracket with a second bracket, wherein the projection of the first piston rod and the projection of the second piston rod are in a line.

14. The steering damper according to claim 13, wherein the steering damper is disposed on a back of the under bracket.

15. The steering damper according to claim 13, wherein the steering damper is disposed in parallel with a length of the under bracket.

16. A saddle-type vehicle comprising the steering damper of claim 13.

17. A motorcycle comprising the steering damper of claim 13.
